(19) United States
(12) Patent Application Publication
(10) Pub. No.: US 2006/0088044 A1
(43) Pub. Date: Apr. 27, 2006

(54) Node for a bus network, a bus network and a method for configuration of the network

(76) Inventor: Robert Hammerl, Hohenthann (DE)

Correspondence Address: EDWARDS & ANGELL, LLP, P.O. BOX 55874, BOSTON, MA, 02205, US

(21) Appl. No.: 11/254,209

(22) Filed: Oct. 19, 2005

(30) Foreign Application Priority Data
Oct. 26, 2004 (DE) 10 2004 052 075.5

(51) Int. Cl. H04L 12/28

(52) U.S. Cl. 370/402

(57) ABSTRACT

Inter alia, the invention provides a node (16) for a bus network, which has a bus controller (30) having a receiving and transmitting circuit arrangement (32) and having a bus connection for transmitting and receiving messages via the bus (14), and has a node identification set device (34, 30) for setting a node identification, on the basis of which the node (16) can respond via the bus (14) and/or the node can be identified in the network and/or on the basis of which messages sent from the node and/or message contents can be identified and/or on the basis of which messages which are relevant for the node and/or message contents can be identified. The invention provides that the node (16) has at least one set input connection (42) which is associated with the node identification set device and is separate from the bus connection, and that the node identification set device (34, 30) can be activated by application of a set signal to the set input connection (42) to receive a nominal node identification via the set input connection and/or the bus connection, and to set this nominal node identification as the node identification.

A first aspect of the invention relates to a node for a bus network, which has a bus controller having a receiving and transmitting circuit arrangement and having a bus connection for transmitting and receiving messages via the bus, and has a node identification set device for setting a node identification, on the basis of which the node can respond via the bus and/or the node can be identified in the network and/or on the basis of which messages sent from the node and/or message contents can be identified and/or on the basis of which messages which are relevant for the node and/or message contents can be identified.

A second aspect of the invention relates to a bus network having a plurality of such nodes. A third aspect of the invention relates to a node which may possibly be referred to as a master node for a bus network such as this, which has a bus controller with a receiving and transmitting circuit arrangement and with a bus connection for transmitting and receiving messages via the bus, and which is designed to configure other nodes in the network. A fourth aspect of the invention relates to a method for configuration of a network such as this.

In this case, the expression “node” can represent any appliance or any device which can be connected to the bus for data communication via the bus with at least one other node, for example for controlling this appliance or this device via the bus or for receiving data from the appliance or the device via the bus, or else for only one component element, which allows appropriate data communication, of in principle any desired appliance or in principle any desired device.

The expression “station” or “unit” could also be used instead of the expression “node”. One example of a corresponding bus system or a corresponding network is the so-called CAN-bus or a CAN-bus network designed on the basis of the CAN-bus. The abbreviation CAN is short for “Controller Area Network”, and is a bus system which was originally developed by the Bosch and Intel Companies as a bus system for vehicles (so-called “Autobus”) which, however, since then has also been proven in the field of automation engineering and other industrial applications as a fieldbus. With regard to the CAN-bus system on which this is based, reference is made to the CAN protocol in accordance with ISO Standard 11898, which also defines the electrical parameters for physical transmission via the CAN-bus. Corresponding bus driver chips and CAN controller chips are available as standard modules. The CAN protocol relates to the physical layer (layer 1) and to the data link layer (layer 2) in the ISO/OSI difference model.

The CAN-bus is a serial bus system in which all of the connected stations have equal authority, that is to say each appliance (each CAN node) can transmit and receive at any time. The CAN network, which is formed on the basis of the CAN-bus, has a linear structure, and the bus system is still fully available for all the other stations if one station fails.

One important aspect of CAN-bus data transmission is that no stations or nodes are addressed, but that the content of a message is identified by a unique number code (identifier). In addition to this content identification, the identifier also defines the message priority. The data is transmitted in accordance with the so-called producer consumer model. The CAN-bus has a multimaster capability, which means that each station (each node) can initiate a bus action autonomously at any desired time. In the event of collisions, arbitration takes place at the bit level on the basis of the priority defined by the identifier, with a collision being identified by a sender itself reading back the identifier sent by it and carrying out a comparison process, and, in the event of inequality as a result of a dominant level from another subscriber superimposed on its own recessive level on the bus, identifying that the other subscriber has likewise sent a message, but with a higher priority. In this context, reference is made to extensive primary and secondary literature references relating to the CAN-bus and the CAN protocol.

Building on the CAN protocol, further protocols have been defined specifically for applications in automation engineering, such as the protocols DeviceNet, SDS (Smart Distributed System), CAL (CAN Application Layer) and CANopen. The CANopen protocol is a standardized protocol which relates to the application layer (layer 7) of the OSI/ISO layer model and dispenses with the multimaster capability of the CAN-bus in favour of simpler network management, introducing a CAN master node which carries out the network management tasks. All the other CAN nodes are implemented as so-called slave assemblies. According to CANopen, the communication between the subscribers predominantly corresponds to the client server model or client slave model. Process data, in contrast, is predominantly still transmitted on the basis of the producer consumer model.

Reference is also made to extensive primary and secondary literature references relating to CANopen and to the other protocols, which are more remote from the hardware, in particular also to the documentation, quasi-standards and specifications issued by CiA e.V. (CAN in AUTOMATION Users and Manufacturers Group e.V.).

According to the CANopen protocol, at least the communication based on the client server model is based on node identifications which are allocated to each of the nodes and can also be referred to as the appliance address or node address. On the basis of the node identification, which in many appliances is set by means of DIP switches, solder links or links on the cable harness, the CANopen protocol then results in a preset range of identifiers which the respective appliance then uses as an identifier in messages sent via the CAN-bus, or to which the appliance reacts when the relevant identifier is included in a message received via the CAN-bus. In addition to hardware setting of the node identification by means of DIP switches, solder links, cable harness links and the like, there are also CAN nodes in which the node identification is preprogrammed in software or, for example, can be programmed in software by means of a serial interface which is provided particularly for this purpose.

Node identifications play a role not only for CAN nodes which are intended for use as a CANopen client but also for simple CAN nodes without any CANopen functionality, which have an integrated CAN protocol controller and can be connected as low-cost input and output components to the CAN-bus. Reference is made in particular to the so-called SLIO modules (Serial Linked I/O modules) which, for example, allow the inclusion of sensors and actuators without local intelligence in a CAN network. SLIO-CAN nodes such as these have a node identification, some of whose bits are, for example, permanently preset by the manufacturer while other bits can be set via port pins or DIP switches, allowing configuration of the node via the CAN-bus.

Irrespective of the nature of the bus (serial, parallel, linear, non-linear, etc) and the refinements of the respectively used protocol (client server model, producer consumer model, hardware-based, remote from hardware, etc), problems always arise whenever the correct operation of a network depends on node identifications. For example, when the node identifications are configured by means of DIP switches, solder links or links in the cable harness, faults can occur which result in an incorrect node identification. A fitter could thus set the wrong identification, or bad contacts could occur during operation as a result of moisture or dirt, corrupting a node identification which has been correctly set per se. Furthermore, when the node is installed, for example, in a commercial motor vehicle or in an industrial manufacturing plant or the like, a large amount of effort is involved when the node must be programmed in software at a respective programming interface before or after installation, or when the node identifications must be set during installation by means of links in the cable harness or by operation of DIP switches or the like. If, according to another conventional variant, the nodes are actually preconfigured by a supplier by setting respective node identifications, then this results in correspondingly greater storage and logistics complexity, since nodes which are functionally intrinsically identical and differ only in the node identification must be kept available and must be supplied correctly to the respective installation locations.

The invention is based on the object of allowing configuration of nodes in a network independently of a node identification which has already previously been correctly set.

In order to achieve this object, the first aspect of the invention provides a node for a bus network, which has a bus controller having a receiving and transmitting circuit arrangement and having a bus connection for transmitting and receiving messages via the bus, and has a node identification set device for setting a node identification, on the basis of which the node can respond via the bus and/or the node can be identified in the network and/or on the basis of which messages sent from the node and/or message contents can be identified and/or on the basis of which messages which are relevant for the node and/or message contents can be identified. The invention provides that the node has at least one set input connection which is associated with the node identification set device and is separate from the bus connection, and that the node identification set device can be activated by application of a set signal to the set input connection to receive a nominal node identification via the set input connection and/or the bus connection, and to set this nominal node identification as the node identification. The aim in particular is for the node to have one and only one set input connection which is associated with the node identification set device and is separate from the bus connection.

The set input connection allows in each case one node of a plurality of nodes in the bus network to be addressed specifically, whose node identification is configurable, without the node having to be addressed via a node identification which has already been set or predetermined. This allows a master node or master computer to include all the nodes which are connected to the bus successively in the network by addressing the respective next node to be included in the network via the set input connection, with this node then receiving the nominal node identification to be set, preferably via the bus. In principle, a star topology could be provided for this purpose, in which each node is connected individually to the master node via a set line arrangement and can be addressed by the master node. In contrast, the nominal node identification would preferably be sent from the master node via the bus, and to this extent would be received by every node connected to the bus. However, only that node which is addressed via its set input connection would adopt and set the nominal node identification received via the bus as a new node identification.

It should be noted that, in principle, it is also possible for the node identification to be received by the respective node via the set input connection, for example in the course of an analogue coding process, in which a respective signal level range represents a defined node identification. Such coding of the node identifications by means of signals which are applied to the set input connections can be used particularly expediently for the star topology, which is to a certain extent superimposed on the actual bus topology of the network, on the basis of the set input connections which are each individually connected to the master node.

More specifically, with regard to the configuration of the nodes by means of nominal node identifications which are transmitted via the bus, it is proposed that the node identification set device can be activated by application of the set signal to the set input connection in order to set a nominal node identification, which is contained in a set message received via the bus connection, as the node identification. In this context, it has already been indicated that the node is preferably designed to respond to the set message on the basis of the set signal independently of an instantaneously set or instantaneously not set node identification, and to set the nominal node identification contained in the received set message as the node identification.

In comparison to the star node network mentioned above as one embodiment option and based on the set input connections (star topology), a linear topology is clearly preferable, since it is more compatible with the actual bus topology of the network. For this purpose, it is proposed that the node have at least one set output connection, which is associated with a set signal output device and is separate from the bus connection, and that it be possible to activate the set signal output device in order to emit a predefined set signal, or a set signal which corresponds to the set signal received at the set input, via the set output connection. The aim in particular is for the node to have one and only one set output connection which is associated with the set signal output device and is separate from the bus connection.

According to this development proposal, a respective node in a chain of nodes can be selected and activated for the configuration of the node identification by activating an immediately adjacent node, whose set output connection is connected to the set input connection of the relevant node, to emit the set signal. By way of example, an already configured node can be addressed by the master node on the basis of its node identification and can be instructed to address the next node in the chain via its set output connection to cause this next node to take its nominal node identification from a corresponding message on the bus. Another possibility is for in each case one already configured node to be activated via its set input connection to emit the set signal at its set output connection. For the latter refinement option, it is specifically proposed that the set signal output device be designed to monitor the set input connection for the end of a set signal applied to it, and to emit the set signal in reaction to the end at the set output connection. In order to make it possible to address nodes which are located further away from the master node in the chain in this way to also emit the set signal, it is possible to provide for this addressing of the node to take place by means of an adjacent node in the chain, which is closer to the master node. This adjacent node can be activated by means of a message sent via the bus to end its emission of the set signal at its set output connection. In this context, it is specifically proposed that the node be designed to monitor the bus for the occurrence of a next node set message when the set signal is emitted at the set output connection, and to end the emission of the set signal at the set output connection in reaction to the occurrence of the next node set message. The aim in particular in this context is that the node is designed to respond to the next node set message on the basis of the existing output of the set signal at the set output connection, independently of addressing of the next node set message at the node on the basis of the node identification, and to end the emission of the set signal at the set output connection.

As already mentioned, it is also possible, however, as an alternative for the node identification of a respective further node to be configured by addressing an already configured adjacent node. For this purpose, it is proposed that the node is designed to monitor the bus for the occurrence of a next node set message which is addressed to the node on the basis of the node identification, and to emit the set signal in reaction to the occurrence of the next node set message at the set output connection. A further aim in this context is that the node is designed to monitor the bus for the occurrence of a next node set complete message addressed to the node on the basis of the node identification, and to end the emission of the set signal at the set output connection in reaction to the occurrence of the next node set complete message.

The node can advantageously be designed to send an acknowledgement message via the bus in reaction to the reception of the set signal at the set input connection and/or in reaction to a message received via the bus, and/or in reaction to at least one other defined event, with this acknowledgement message containing a component identification which is permanently associated with the node, and the current node identification. This allows the configuration of the network and the adoption of an instantaneous configuration of the network to be monitored. In particular, for simple monitoring of the configuration, in particular by the master node, it is also specifically proposed that the node is designed to send a confirmation message or a/the acknowledgement message via the bus in conjunction with the setting of the node identification, which acknowledgement message contains a/the component identification which is permanently associated with the node, and the set node identification.

In particular for networks which do not have a large extent and contain a relatively small number of nodes, it is advantageous if the node identification set device can be activated by application of a preset set signal, which is not the same as the set signal, at the set input connection to set a preset node identification, which is stored in the node, as the node identification. If, for example, the network comprises only nodes which differ from one another and provide different functions, then it is possible, even before the formation of the network, to preconfigure the nodes with the correct node identification and from the start to obtain nodes with the correct node identification from a supplier, and to this extent to avoid the configuration of the node identifications in the network. In some situations, it may even be advantageous if a plurality of different preset node identifications are stored or can be stored in the node and to be able to select one of the preset node identifications that is to be set as the node identification by means of the preset set signal for setting as the node identification.

A further aspect of the invention (see the third aspect mentioned above) also relates to a node for a bus network having a plurality of nodes according to the invention as mentioned above, which has a bus controller with a receiving and transmitting circuit arrangement and a bus connection for transmitting and receiving messages via the bus, and which is designed to configure other nodes in the network. According to the invention, it is proposed that the node has a network configuration device with at least one set output connection which is associated with a set signal output device and is separate from the bus connection, that the set signal output device can be activated by the network configuration device to emit a predefined set signal via the set output connection, and that the network configuration device is designed to send a set message via the bus connection by means of the set signal output device via the set output connection or—preferably—by means of the bus controller, which set message contains a nominal node identification associated with a node in the network.

A node such as this can expediently be used as the master node in the network in order to configure the node identification of at least one other node in the network. The aim in particular is that the node has one or two, and only one or two, set output connection or connections which is or are associated with the set signal output device and is or are separate from the bus connection, so that the master node can form an outer chain link or an inner chain link in a chain of the plurality of nodes in the network and, in the former case, configures one node after the other in the chain starting with the immediately adjacent node, and in the second case configures the nodes in the two chain elements which extend from it starting with the respective immediately adjacent node, successively at the same time, in an overlapping form or successively.

In order to record an actual configuration state, the node can be designed to send an acknowledgement request message via the bus connection by means of the bus controller. In order to configure nodes which are further away from it in the chain, the node can be designed to send a next node set message and, possibly, a next node set complete message via the bus connection by means of the bus controller.

The node is preferably designed to receive by means of the bus controller at least one acknowledgement message or confirmation message, which is sent in response to the transmitted acknowledgement request and/or in response to the emission of the set signal via the bus and/or in response to the transmitted next node set message, and to compare the content of this acknowledgement message or confirmation message, which contains a node identification and a component identification, with predetermined network configuration data. The network configuration data may, for example, be configuration data which has already been stored in a memory or is received at an interface. In this context, the possibility should be mentioned that the node identifications for the nodes in a network can expediently be coded on the basis of data from a goods administration system. This data can expediently be stored in a read only memory in the master node, in order to provide for initial configuration and, at a later time, for a subsequent configuration process, which is carried out as required, as well.

In this context, as a development, it is proposed that the node is designed to send or not to send the set message as a function of the content of the acknowledgement message and/or as a function of the comparison, and/or to send the set message with a nominal node identification which is dependent on the comparison and is defined on the basis of the network configuration data.

As has already been mentioned explicitly and implicitly, the respective node (master node as well as a single client node which can be configured by the master node) for a network can be provided on the basis of a linear bus. For this purpose, the bus controller is designed with the receiving and transmitting circuit arrangements to transmit and to receive messages via the linear bus. One particular aim is for the node for a network to be provided on the basis of a serial bus.

The bus controller is then designed with the receiving and transmitting circuit arrangement in order to transmit and to receive messages via the serial bus. The bus that has been mentioned may, in particular, be a so-called fieldbus. The node can thus be provided for a fieldbus network. The bus controller is then in the form of a fieldbus controller with a receiving and transmitting circuit arrangement and with a fieldbus connection for transmission and reception of messages via the serial fieldbus.

One particular idea, although this is not exclusive, is for the node to be provided for a CAN-bus network. The bus controller is then in the form of a CAN-bus controller with a CAN receiving and transmitting circuit arrangement and a CAN-bus connection for transmitting and receiving messages via the CAN-bus. In this context, provision is normally made for the node to be designed for data communication and network control via the CAN-bus in particular in accordance with a CAN protocol which provides message-related addressing which identifies the content of the message. One particular idea is for a protocol which relates to layers 1 and 2 (the physical layer and the data link layer) in the OSI/ISO layer model and is associated with these layers. As a particularly preferred feature, it is proposed that the node is designed for data communication and network control via the CAN-bus in accordance with a protocol which is based on the/a CAN protocol and provides communication and network control in accordance with the master/client principle. This is aimed in particular at a protocol which relates to layer 7 (the application layer) in the OSI/ISO layer model and is associated with this layer, preferably the CANopen protocol. In this context, the invention also provides, in particular, a node which is designed, is configured or can be configured as a client node for the protocol which provides the communication and network control on the basis of the master/client principle. Furthermore, in this context, the invention also provides a node which is designed, is configured or can be configured as a master node for the protocol which provides the communication and network control in accordance with the master/client principle.

The respective node is generally designed for provision of at least one useful functionality, for example an analogue input, analogue output, digital input, digital output, sensor system, actuator system and the like. A node according to the invention can advantageously have a processor arrangement, on the basis of which at least one device or functionality of the node is provided in conjunction with corresponding software and, possibly, additional hardware interacting with it. For example, the node identification set device can be provided on the basis of a processor arrangement which may interact with the bus controller. In conjunction with a software functionality, the processor arrangement could also provide the bus controller functionality. Furthermore, the set signal output device may be formed on the basis of the processor arrangement. The same applies to the set signal output device and to the network configuration device.

A further aspect of the invention (see the second aspect mentioned above) furthermore provides a network, comprising a plurality of nodes according to the invention, in particular comprising at least one master node and a plurality of client nodes, and having a line arrangement which connects the nodes at their bus connections. For the provision on the bus topology, line arrangement segments which extend between the nodes are connected between the bus connections or are at least connected to one another with respect to signals which are transmitted via the line arrangement, or are designed to be continuous from one line arrangement segment to another line arrangement segment in such a way that the line arrangement forms a preferably linear and/or serial network bus, which provides mutually parallel, mutually independent reception of messages transmitted via the bus by a plurality of nodes. The line arrangement is preferably an electrical line arrangement. However, it may possibly also be an optical waveguide arrangement.

A plurality, or preferably all, of the nodes of the network preferably form a chain of nodes which are connected by means of set line arrangements at their set input connections and set output connections, with the set line arrangements extending in pairs between the nodes and not being continuous from one set line arrangement to another set line arrangement. A respective set line arrangement is preferably formed by a single line which connects one pair of nodes to one another. Apart from an electrical connection, this may also be an optical connection.

For simple handling and simple design of the network, including the connection between the set input and output connections as well, it is preferable that, at least for one of the nodes, and preferably for all of the nodes, the bus connection and the set output connection and—in the case of the client nodes—the set input connection have a common bus connecting connector, for example a so-called backplane connector or the like. Although the connection between the set input and output connections has no bus topology and to this extent cannot be regarded as part of the network bus, the development proposal means that the chain-like connection is joined together via the set input and output connections and set line arrangements to a certain extent with the network bus, and can be handled jointly, in terms of the production of the required connections. Considered on a somewhat coarser basis, which is based more on what the fitter actually does, it will to this extent normally also be possible to speak of a bus in this way being provided with additional functionality, which simplifies the node identification for the configuration of the nodes.

It has already become sufficiently clear that the network may be in the form of a CAN-bus network. The nodes are then designed to transmit and receive messages via the bus, which is in the form of a CAN-bus. It has also already been mentioned that the nodes can be designed for data communication and network control via the CAN-bus in accordance with a CAN protocol, in particular in accordance with a message-related CAN protocol which provides addressing that identifies the content of the message. One aim in particular is that the nodes are designed for data communication and network control via the CAN-bus in accordance with a protocol which is based on the/a CAN protocol and provides communication and network control on the basis of the master/client principle, preferably on the basis of the CANopen protocol, in which case one node, preferably the master node for the network configuration, is designed, is configured or can be configured as the master node for the protocol which provides the communication and network control on the basis of the master client principle, and the other nodes are designed, are configured or can be configured as client nodes for the protocol which provides the communication and the network control based on the master client principle.

A further aspect (see the fourth aspect mentioned above) of the invention also provides a method for configuration of a network according to the invention, in which at least one master node according to the invention configures a plurality of client nodes according to the invention, in that the master node successively sends at least one set message by means of the bus controller via the bus for each client node to be configured, which set message contains a nominal node identification associated with the respective client node, in which case the nodes to be configured are activated successively by application of a set signal to their set input connection to set a nominal node identification, which is associated with them and is contained in a set message received via the bus connection, as the node identification.

One preferred refinement of the method provides that the master node also sends next node set messages between the set messages and/or ends the emission of the set signal at its set output connection in order that an already configured node emits at its set output connection the set signal which a node that has not yet been configured receives at its set input connection. In order to determine an instantaneous configuration state of the network, the master node can advantageously send at least one acknowledgement request message via the bus connection.

Provision is particularly preferably made that the master node receives at least one acknowledgement message or confirmation message, which has been sent in response to the transmitted acknowledgement request and/or in response to the emission of the set signal via the bus and/or in response to the transmitted next node set message and/or in response to the transmitted node set message, from a respective client node or the client nodes, and compares its content, which contains a node identification and a component identification, with predetermined network configuration data. In this context, it is also proposed as a development that the master node sends or does not send the set message as a function of the content of the acknowledgement message and/or as a function of the comparison, and/or sends the set message with a nominal node identification which is dependent on the comparison and is defined on the basis of the network configuration data.

Further refinement options of the method are evident, inter alia, from the above statements relating to the invention and development proposals based on the first, second and third aspect of the invention.

The invention will be explained in more detail in the following text with reference to exemplary embodiments which are shown in the figures and on the basis of scenarios which result from the further text, from which further refinement and development options of all of the aspects of the invention will become evident. In the figures:

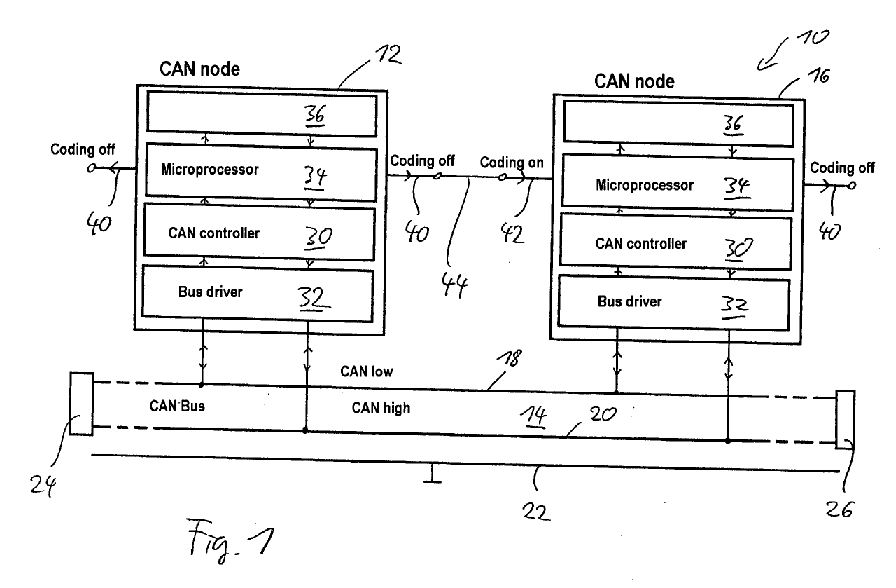

FIG. 1 shows, schematically, a detail of one exemplary embodiment of a network formed on the basis of the CAN-bus, in which a plurality of CAN nodes, in addition to being coupled via the CAN-bus, are coupled in pairs to coding outputs and inputs which are used to set node identifications.

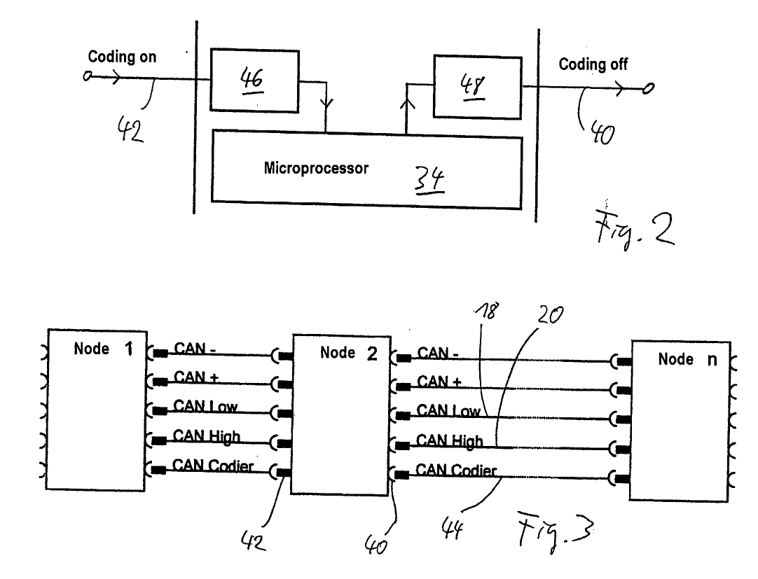

FIG. 2 shows, schematically, a section of a CAN node with a coding input and a coding output, and associated circuits.

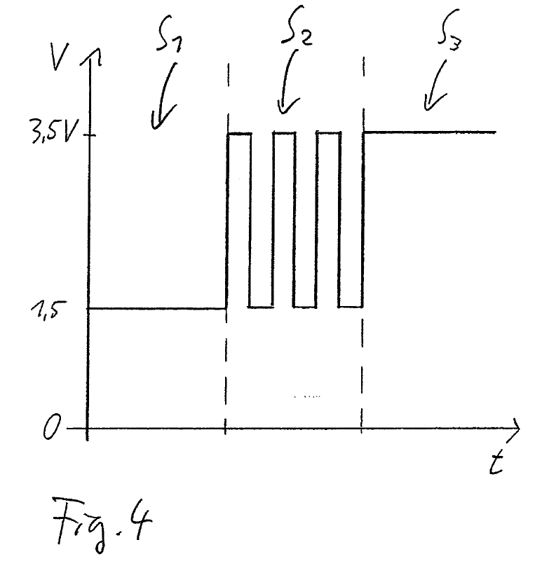

FIG. 3 shows, schematically, a chain of CAN nodes with CAN-bus lines which extend between the nodes and are based on the CANopen Standard, and CAN coding lines which are additionally provided according to the invention and are used for setting node identifications.

FIG. 4 shows one example of possible signal states of a coding signal which is emitted from the coding output of one node, and is applied to the coding input of another node.

The invention will be explained in more detail in the following text on the basis of the CAN-bus and on the basis of a CAN network, without any intention of this restricting the invention. Other bus systems and bus network types are likewise feasible. According to one preferred exemplary embodiment, the invention can be regarded as a development in the context of and as an extension to the CANopen Standard. According to this Standard, node identifications which are allocated individual CAN nodes play an important role in the communication between nodes on the CAN-bus. Each node must be assigned a unique node identification (node number or ID). At present, this is done by means of a software setting in the node, by means of DIP switches or by means of a coding pin at the node in conjunction with links in the cable harness which connects the nodes. Both conventional options have significant disadvantages. For example, identification setting by means of software parameters requires unique parameter allocation for the identification before the respective component is installed in the network. For this purpose, either a parameter setting option which is independent of the CAN-bus is required, or the component has a preset, which occurs only once in the CAN network. Without excessive logistics complexity, the latter is impossible when identical components are intended to be used a number of times within a network. In contrast, hardware coding by means of DIP switches or coding pins involves considerable coding effort, to be precise more effort the greater the number of identical components that are used in the network. There is a risk of incorrect codings and a risk of contact problems (aging, moisture etc) during evaluation of the hardware coding leading to incorrect identifications.

In comparison to these conventional solutions, one preferred exemplary embodiment of the invention achieves considerable improvements in that the network nodes (the CAN nodes according to the exemplary embodiment used as the basis here) have a controllable coding output which is connected to a coding input of the next node in a chain of nodes. The first component in the chain uses its controllable coding output to signal the coding wish to the next component. The next component then reads its node identification via the signal at the coding input or via a defined message on the bus (in this case on the CAN-bus). Once the node identification obtained in this way has been set, the component can register in the network, and can signal the coding wish to the next component after it, via its coding output. This allows the components to be included, one by one, in the network along the CAN bus.

The node identification that has been set allows normal communication via the bus in accordance with one of the relevant standards, for example in accordance with the CANopen Standard. According to this, the node identification (in particular a respective node number 1 to 127) is part of an identifier of a respective CANopen message (in particular 11 bit identifier). According to CANopen, eight bits of payload data are available as standard, of which, for a CANopen slave node by way of example, 4 bytes are available for input data (for example output levels from four analogue outputs), and 4 bytes are available for output data (for example measured levels of four analogue inputs).

By way of example, FIG. 1 shows a detail from a CAN-bus network 10, having one master node 12 and a plurality of client nodes 16 which are connected to the master node via the CAN-bus 14, but of which only one is shown in FIG. 1. The expressions “master” and “client” in this case relate primarily to the master node controlling the node identification for the configuration of the client nodes, via the CAN-bus and an additional paired coding connection between the nodes. If a protocol based on the master/client or master/slave principle is used, then the master node for the identification configuration process is preferably at the same time, however, also the master node in accordance with this protocol, that is to say by way of example the CANopen master, and client nodes whose identification configuration is controlled by the master node are also at the same time the client nodes or slave nodes in accordance with the protocol.

The communication via the CAN-bus 14 takes place via a CAN low line 18 and a CAN high line 20, to which voltage levels which are defined with respect to a reference ground 22 (CAN−) are applied from a node which is sending a message, for example a dominant level of 3.5 V for CAN high and 1.5 V for CAN low, corresponding to a logic 0, and a recessive level of 2.5 V for CAN high and 2.4 V for CAN low corresponding to a logic 1. The important factor is the difference signal between CAN high and CAN low. The CAN nodes are attached to the linear bus 14 in parallel with one another, and the two ends of the linear bus 14 are terminated by terminating resistors 24 and 26.

On the basis of a normal embodiment, a respective node can be formed with a dedicated CAN controller 30, which is attached to the CAN-bus 14 via a bus driver circuit arrangement 32. The bus driver circuit can be functionally subdivided into a transmitting circuit and a receiving circuit. The CAN controller receives output data to be transmitted via the bus from a microprocessor 34, and passes on input data received via the bus to the microprocessor 34. It should be noted that the microprocessor 34 could also itself carry out the function of the CAN controller if provided with appropriate operating software, so that the block 30 in the nodes shown in FIG. 1 could just represent a corresponding functionality of the node, implemented on the basis of the microprocessor and of software. A block 36 represents in a general form further functionalities of the respective node, which are provided by dedicated hardware and/or by operating software in conjunction with the microprocessor, in particular and in addition for useful functionalities of the node such as the recording of processed data, the emission of control data, actuator systems etc. Any desired functionalities which are known in conjunction with the CAN nodes in the specialist world can be implemented.

According to the invention, the nodes have functionalities which are used for configuration of the node identification of the nodes, on the basis of an embodiment of the client nodes and of the master node, in each case with at least one coding output 40 and the client node in each case with at least one coding input 42. As illustrated in FIG. 1, a master node 12 preferably has two coding outputs 40, and a client node 16 preferably has one coding input 42 and one coding output 40. A master node 12 can then be arranged either as an end node or alternatively between client nodes in a chain of client nodes 16. The chain of nodes is defined by the connection of the coding outputs and inputs in pairs by means of coding lines 44, which are connected at one end to the coding output 40 of one node, and at the other end to the coding input 42 of the other node. This connection of the nodes in the form of a chain preferably corresponds to the sequence of the nodes on the linear CAN-bus 14.

A signal which is applied to the coding input 42 is received by a receiving circuit 46, which signals recorded drive states of the coding input by means of appropriate signals or data to the microprocessor 34. The microprocessor 34 can itself emit defined output signals via the coding output 40, by driving an output circuit 48. Reference is made to FIG. 2. The master node can be designed accordingly, with one or more output circuits 48 associated with its at least one coding output 40, or in this case a plurality (two) of coding outputs 40.

It should be noted that it is normally feasible to use conventional nodes in a pure hardware consideration for the embodiment of the invention, specifically for a master node a node such as this which has at least one controllable analogue input, and for a slave node a node such as this which has at least one analogue input and at least one analogue output, in which case an analogue input such as this is then used as the coding input, and an analogue output such as this is used as the coding output. These inputs and outputs can then be connected by means of coding lines in order to form the chain of nodes, and, by appropriate programming of the microprocessor for the nodes with appropriate functionalities, it could be equipped for setting of the node identification on the basis of a coding signal which is applied to the coding input and for addressing an adjacent node for setting of the node identification by emitting a coding signal at the coding output.

Continuously or at least in a monitoring state which can be initiated by at least one defined event, the microprocessor 34 monitors the coding input to determine whether or not a set signal (coding signal) is being applied to the coding input. The coding outputs of the master node and of the client nodes can thus assume at least two logic states, which may be referred to as “passive” and “active”, with the “active” state corresponding to the set signal, and the “passive” state corresponding to there being no set signal. The set signal may, for example, be a signal which alternates between two voltage levels, for example corresponding to the signal S2 as shown in FIG. 4, while, in contrast, the “passive” state could correspond to a constant level (level 0 or connected to ground or—preferably—a defined voltage level greater than 0, for example corresponding to the signal S₁ shown in FIG. 4). A defined level greater than 0 or some other defined signal which forms the “passive state” offers the advantage that a coding line connection which has not been made correctly or has been interrupted can be identified at a respective coding input.

When the “active” state or the set signal (for example the signal S₂) is received at the coding input, then this initiates an identification set routine on the basis of the monitoring by the microprocessor or alternatively in the course of the initiation of an interrupt, which identification set routine waits, in accordance with the exemplary embodiment used as the basis here, for a defined set message being sent via the bus, and, once this has been received by means of the bus driver 32 and the CAN controller 30, receives a nominal node identification, and sets this as the node identification. The set message is sent from the master node via the bus 14, and can in principle be received by all of the client nodes attached to the bus. The identifier in this set message does not address a specific client node on the basis of the node identification, since this node identification has possibly not yet been set, is not yet correct, or has not yet been set unambiguously. The choice of the node which is intended to set the nominal node identification contained in the set message as its own node identification is made by means of the set signal which is applied to the coding input of the relevant node.

The master node 12 directly addresses the first node in the client node chain that is connected to the master node, via the coding output 40 of said master node 12, and the coding line 44 at the coding input 42. The subsequent client nodes are addressed at the coding input by that client node which is immediately adjacent to it in the direction of the master node and whose node identification has already been configured by the master node, by this immediately adjacent client node emitting the set signal at its coding output. In order to also be independent for this next node addressing from the addressing of the node via its node identification, it is advantageously possible to provide for a respective client node to end the reception of the set signal after reception of the set signal at its coding input (“active” state), that is to say with the coding input changing to the “passive” state again, with the relevant node reacting to this by now itself emitting the set signal at its coding output 40 in order in this way to address the next client node in the chain, and to initiate the code identification set routine there. A respective preceding node, which is currently emitting the set signal at its coding output, is preferably caused to no longer emit the set signal by means of a next node set message, which is sent from the master node via the bus. The next node which was actually previously being configured on the basis of the emitted set signal then reacts to this by emitting the set signal at its coding output, in order to supply the set signal to the coding input of the next client node which has not yet been configured.

One expedient configuration scenario, which should be regarded only as an example, is as follows:

When the system is switched on, a central location checks whether all of the CAN nodes can communicate. In the case of CANopen based on the master-slave principle (master client principle), the CANopen master node for this purpose communicates by means of NMT services (Network Management Object services) and/or SDO services (Service Data Object services) with the CANopen slaves. As mentioned, it is expedient for the CANopen master at the same time also to be the master node for the node identification configuration process. However, in principle, another node could also carry out the master function for the node identification configuration process and, if this is the case, it is referred to, for example, as the “CAN Node ID” master or “CAN Note ID” master, to distinguish it from the CANopen master.

If it is not possible to communicate with all of the CAN nodes on switching on, that is to say the CAN nodes cannot all be “attached to the bus”, then this may be because one or more of the nodes currently have an incorrect node identification (“CAN Note ID”), or because individual nodes do not yet have a node identification. In this situation it is possible, by way of example, for all of the CAN nodes to be provided with the correct node identification in the following way:
1. First of all, the master node switches its coding output (“CAN Note ID Out” output) to be active, that is to say the master emits the set signal (for example the signal S₂) at the coding output.
2. A CAN node (during the first run through the CAN node which is immediately adjacent to the master node) registers at its coding input (“CAN Note ID In” input) a change from passive to active, that is to say it receives the set signal. As a reaction to this, the node emits a CAN message in which it signals its fixed predetermined component identification and its current node identification.
3. The master node waits for a response and evaluates the response—if received. If no response is received after a predetermined waiting time or a component registers whose node identification does not correspond to a predetermined nominal node identification, then the master node sends a CAN message (set message) via the bus, containing at least that nominal node identification which is associated with that component and preferably and additionally also the component identification which is expected by the master for the relevant node. In addition, a check is preferably also carried out on the basis of the fixed predetermined component identification which cannot be changed, in order to make it possible to identify faults in the design of the network. If a component which is unexpected on the basis of the component identification registers, then the master node signals a component fault to a higher-level application.
4. A CAN node (during the first run through the node which is arranged immediately adjacent to the master node) receives a CAN message (set message) which contains a nominal node identification (“CAN Note ID”) and preferably a component identification as used by the master node for the allocation of the nominal node identification to the node. Only that CAN node which has the active coding input continues to evaluate the CAN message (set message). If the component identification stated in this message matches its own, then the node continues to evaluate the nominal code identification (“CAN Note ID”) and sets the nominal node identification as the new node identification. As a reaction to this, the node finally sends a CAN message with its own component identification and the new node identification (“CAN Note ID”), which has been accepted on the basis of the evaluation, via the bus.
5. The master node waits for a response and evaluates the response—if it is received. If there is no response after a predetermined waiting time, or an unexpected component signals with respect to the component identification and/or an unexpected node signals with respect to the node identification, then the master node signals a fault to the application. In any case, the master node now switches its coding output to passive, assuming it was previously active, or sends a CAN message (next node set complete message or “CAN Note Next” message) via the bus whose meaning is “switch onwards”.
6. A CAN node receives the “next node set complete message” or “CAN Note Next” message via the bus. That node which is currently emitting the set signal at its coding output, that is to say the coding output is in the active state, switches this output back to passive on receiving this message, thus ending the emission of the set signal.
7. A CAN node registers a change from the active state to the passive state at its coding input. As a reaction to this, the node on the one hand sets its coding output to active, that is to say it emits the set signal there. This switches the node identification configuration to the next node in the node chain.
8. Steps 2 to 7 are carried out once again, until the master node identifies all of the CAN nodes in a node identification chain (“CAN Note ID” chain) and the node identifications (“CAN Note ID”) for the nodes have been configured or reconfigured. Once a node has already set the correct node identification, there is no need to reconfigure this identification.

Two CAN identifiers (possibly a CAN identifier outside the CANopen Standard) are required for the configuration mechanism on the basis of this scenario, in order to identify the messages sent from the master node and those sent from the CAN nodes. The master node uses the one CAN identifier, and the slave nodes use the other CAN identifiers. The client nodes can distinguish between the messages with different meanings sent by the master node on the basis of this scenario on the basis of information coded in the payload data fields, and can receive the component identification and the nominal node identification in the case of the set message.

In addition to dynamic allocation of node identifications to the individual nodes in the network, a diagnosis can also be carried out in a corresponding manner to determine which CAN nodes are connected to the bus and whether they are communicating correctly.

It is also possible to provide for the master node to request acknowledgement messages from all of the connected nodes at least after switch-on, and possibly also in reaction to other events or at regular intervals, by means of a message which is sent via the bus, containing the respective node identification (node ID) and, preferably, a respective permanently allocated component identification as well. If all of the nodes respond correctly with the intended node identifications, there is then no need for configuration of the network. On the other hand, if some nodes are missing or a plurality of nodes respond with the same node identification, then the network configuration process according to the invention can be carried out, for example using the above scenario.

The following should also be noted. Conventionally, it is also possible to configure the message identifiers used for CAN nodes, for example so-called SLIO nodes, via the CAN-bus. This configuration process is carried out on the basis of a respective unique node identification, in order to allow the respective node to be addressed unambiguously via the CAN-bus at all. The invention does not relate, or at least does not directly relate, to the configuration of nodes, with regard to message identifiers which are used in messages for identification of the message content, but to the configuration of the node identification itself, on whose basis a wide configuration process can then be carried out for the respective nodes, for example also with respect to the message identifiers that are used, provided that these are not predetermined on the basis of the node identification that has been set or when predetermined message identifiers are intended to be amended on the basis of the node identification.

It is feasible to extend the CANopen protocol software or other application software such that a respective component is reconfigured automatically or possibly quasi-instantaneously after reception of a nominal node identification (“CAN Note ID”) on the basis of appropriate predetermined configuration data, but preferably only after the “Reset Communication” NMT state has been run through via the bus, in order to create defined conditions. In this way, components could be passed to the CAN-bus or could be included in an existing CAN network by a master node in a “Plug and Play” manner.

Although the coding lines which extend between the CAN nodes do not have a bus character and to this extent, strictly speaking, cannot be regarded as an extension to the conventional CAN-bus, it is, however, expedient to provide for these lines to be integrated with the actual bus lines to form a quasi-bus which supports the node identification coding function. While the actual bus lines are looped through to the next node at the individual nodes this does not, in contrast, apply to the coding lines. According to the CANopen Standard, the following lines are conventionally provided: CAN− (0 V), CAN+ (24 V), CAN low and CAN high. The 24 V from CAN+ is used primarily for supplying voltage to the CAN-bus controller. Depending on the power consumption, the voltage supply can also be provided for further functionalities of the CAN node on the basis of the supply voltage for the CAN+ line. For a high power consumption and in order to avoid interference on the bus, it is, however, generally preferable to provide a separate voltage supply for the other node functionalities.

The coding line (CAN coder) is also added to the line that has been mentioned on the basis of the CANopen Standard on the basis of the preferred refinement of the invention mentioned here, with the coding signal preferably being related to the ground potential (0 V) of CAN−. These lines, including the CAN coding line, are preferably combined to form a quasi-bus, by adding corresponding coding connections (input pin, output pin) to a bus connection which is provided for connection to a backplane. The normal useful connections for example of an appropriate plug-in board are preferably provided on a front panel.

According to one preferred refinement, the coding input (“CAN Note ID In input”) can also be used as a conventional coding input. If, on the switch on, the component finds, for example, a constant high level (for example the signal S₃ in accordance with FIG. 4) or some other unambiguous preset set signal at the coding input, then it sets its node identification (“CAN Note ID”) to a preset identification defined in the component (a value which is defined in the component). In order to make it possible to reliably distinguish between such setting of the node identification on the basis of identifications which are predefined in the individual components and the setting of a nominal node identification received from a master node, is expedient to use drive states which can be distinguished unambiguously, that is to say for example a dynamic signal, in particular a signal which switches backwards and forwards between two levels, for the configuration of the node identification on the basis of a set message which is transmitted via the bus and a constant (static) high-level signal for setting the node identification on the basis of a preset node identification loaded in the node in advance. In order to allow appropriate preset set signals to be applied to all the nodes in a node chain, it is possible to provide for each node which receives a preset set signal at its coding input to likewise emit the preset set signal at its coding output. Another possibility when setting up the network is for all the nodes which are intended to set the preset identification, which was loaded in the node in advance, as the node identification to have their coding inputs connected by means of an appropriate link to CAN+, in order to apply the high-level signal from CAN+ to the coding input, which, in contrast to FIG. 4 on the basis of CANopen, could be at a higher voltage level, in particular at a voltage level of 24 V.

By way of example, FIG. 3 shows a chain of CAN nodes in which the CAN-bus is provided by line arrangements which extend in pairs between the nodes. The lines CAN−, CAN+, CAN low and CAN high are looped through in the respective node between female connections on the one side and male connections on the other side. The coding line which is combined with the other lines, for example, in a cable is in contrast not looped through in the nodes between the male connections and the female connections, and the corresponding coding connections of the node differ by their functions as a coding input 42 and coding output 40.

Advantages of the invention and its developments as well as the exemplary embodiments considered are, inter alia, as follows:
Any desired number of identical components can be included in the network, in particular the CAN network, without any need for presetting by software, or via hardware links or the like. All that is necessary is to connect the coding output at each component to the coding input of the next component. The complexity for setting the node identifications, that is to say in particular, for example, the complexity for links in the cable harness, then no longer increases with the number of components in the network.
Since a node which is in each case to be configured can be addressed uniquely on the basis of the coding inputs, the node identifications of the nodes can be configured in software via the bus without any need to address individual nodes via a node identification for this purpose.
Contact problems resulting from aging or environmental influences and installation faults can no longer lead to incorrect node identifications, thus increasing the reliability of corresponding networks and reducing the test effort. The configuration of the node identifications of the nodes in the network via the bus can advantageously be provided only when required, for example when the nodes do not all respect with their correct node identification when the network is switched on or in response to an appropriate acknowledgement request.

1. Node for a bus network, which has a bus controller having a receiving and transmitting circuit arrangement and having a bus connection for transmitting and receiving messages via the bus, and has a node identification set device for setting a node identification, on the basis of which the node can respond via the bus and/or the node can be identified in the network and/or on the basis of which messages sent from the node and/or message contents can be identified and/or on the basis of which messages which are relevant for the node and/or message contents can be identified, wherein the node has at least one set input connection which is associated with the node identification set device and is separate from the bus connection, and in that the node identification set device can be activated by application of a set signal (S₂) to the set input connection to receive a nominal node identification via the set input connection and/or the bus connection, and to set this nominal node identification as the node identification.

2. Node according to claim 1, wherein the node identification set device can be activated by application of the set signal (S₂) to the set input connection to set a nominal node identification, which is contained in a set message received via the bus connection, as the node identification.

3. Node according to claim 2, wherein the node is designed to respond to the set message on the basis of the set signal (S₂) independently of a currently set or currently not set node identification, and to set the nominal node identification contained in the received set message as the node identification.

4. Node according to claim 1, wherein the node has at least one set output connection, which is associated with a set signal output device and is separate from the bus connection, and in that the set signal output device can be activated to emit a set signal (S₂), which is predefined or corresponds to the set signal received at the set input, via the set output connection.

5. Node according to claim 4, wherein the set signal output device is designed to monitor the set input connection for the end of a set signal (S₂) applied to it, and to emit the set signal (S₂) in reaction to the end at the set output connection.

6. Node according to claim 5, wherein the node is designed to monitor the bus for the occurrence of a next node set message when the set signal (S₂) is emitted at the set output connection, and to end the emission of the set signal (S₂) at the set output connection in reaction to the occurrence of the next node set message.

7. Node according to claim 6, wherein the node is designed to respond to the next node set message on the basis of the existing output of the set signal (S₂) at the set output connection, independently of addressing of the next node set message at the node on the basis of the node identification, and to end the emission of the set signal (S₂) at the set output connection.

8. Node according to claim 4, wherein the node is designed to monitor the bus for the occurrence of a next node set message which is addressed to the node on the basis of the node identification, and to emit the set signal in reaction to the occurrence of the next node set message at the set output connection.

9. Node according to claim 4, wherein the node is designed to monitor the bus for the occurrence of a next node set complete message addressed to the node on the basis of the node identification, and to end the emission of the set signal at the set output connection in reaction to the occurrence of the next node set complete message.

10. Node according to claim 1, wherein the node is designed to send an acknowledgement message via the bus in reaction to the reception of the set signal at the set input connection and/or in reaction to a message received via the bus, and/or in reaction to at least one other defined event, with this acknowledgement message containing a component identification which is permanently associated with the node, and the current node identification.

11. Node according to claim 1, the node is designed to send a confirmation message or a/the acknowledgement message via the bus in conjunction with the setting of the node identification, which acknowledgement message contains a/the component identification which is permanently associated with the node, and the set node identification.

12. Node according to claim 1, wherein the node identification set device can be activated by application of a preset set signal (S₃), which is not the same as the set signal (S₂), at the set input connection to set a preset node identification, which is stored in the node, as the node identification.

13. Node for a bus network having a plurality of nodes according to claim 1, which has a bus controller with a receiving and transmitting circuit arrangement and a bus connection for transmitting and receiving messages via the bus, and which is designed to configure other nodes in the network, characterized in that the node has a network configuration device with at least one set output connection which is associated with a set signal output device and is separate from the bus connection, in that the set signal output device can be activated by the network configuration device to emit a predefined set signal (S₂) via the set output connection, and in that the network configuration device is designed to send a set message via the bus connection by means of the set signal output device via the set output connection or—by means of the bus controller, which set message contains a nominal node identification associated with a node in the network.

14. Node according to claim 13, wherein the node is designed to send an acknowledgement request message via the bus connection by means of the bus controller.

15. Node according to claim 13, wherein the node is designed to send a next node set message and, possibly, a next node set complete message via the bus connection by means of the bus controller.

16. Node according to claim 13, wherein the node is designed to receive by means of the bus controller at least one acknowledgement message or confirmation message, which is sent in response to the transmitted acknowledgement request and/or in response to the emission of the set signal via the bus and/or in response to the transmitted next node set message, and to compare the content of this acknowledgement message or confirmation message, which contains a node identification and a component identification, with predetermined network configuration data.

17. Node according to claim 16, wherein the node is designed to send or not to send the set message as a function of the content of the acknowledgement message and/or as a function of the comparison, and/or to send the set message with a nominal node identification which is dependent on the comparison and is defined on the basis of the network configuration data.

18. Node according to claim 1, wherein the node is provided for a CAN-bus network, with the bus controller being designed as a CAN-bus controller with a CAN receiving and transmitting circuit arrangement and with a CAN-bus connection for transmitting and receiving messages via the CAN-bus.

19. Node according to claim 18, wherein the node is designed for data communication and network control via the CAN-bus in accordance with a CAN protocol, in particular in accordance with a CAN protocol which provides message-related addressing which identifies the content of the message.

20. Node according to claim 18, wherein the node is designed for data communication and network control via the CAN-bus in accordance with a protocol which is based on the/a CAN protocol and provides communication and network control in accordance with the master/client principle, preferably on the basis of the CAN open protocol.

21. Node according to claim 20, configured as a client node for the protocol which provides the communication and network control on the basis of the master/client principle.

22. Node according to claim 20, configured as a master node for the protocol which provides the communication and network control in accordance with the master/client principle.

23. Node according to claim 1, wherein the node is designed to provide at least one of an analogue input, analogue output, digital input, digital output, sensor system, and actuator system.

24. Node according to claim 1, wherein a processor arrangement, on the basis of which at least one device or functionality of the node is provided.

25. Network, comprising a plurality of nodes according to claim 1, in particular at least one master node and a plurality of client nodes, and having a line arrangement which connects the nodes at their bus connections, in which case line arrangement segments which extend between the nodes are connected between the bus connections or are at least connected to one another with respect to signals which are transmitted via the line arrangement, or are designed to be continuous from one line arrangement segment to another line arrangement segment in such a way that the line arrangement forms a preferably linear and/or serial network bus, which provides mutually parallel, mutually independent reception of messages transmitted via the bus by a plurality of nodes.

26. Network according to claim 25, wherein a plurality of the nodes form a chain of nodes which are connected by means of set line arrangements at their set input connections and set output connections, with the set line arrangements extending in pairs between the nodes and not being continuous from one set line arrangement to another set line arrangement.

27. Network according to claim 25, wherein at least in the case of one of the nodes, preferably in the case of all of the nodes, the bus connection and the set output connection and, when provided, the set input connection have a common bus connection connector.

28. Network according to claim 25, wherein the network is in the form of a CAN-bus network, with the nodes being designed to transmit and receive messages via the bus, which forms a CAN-bus.

29. Network according to claim 28, wherein the nodes can be designed for data communication and network control via the CAN-bus on the basis of a CAN protocol, in particular on the basis of a CAN protocol which provides message-related addressing identifying the content of the message.

30. Network according to claim 28, wherein the nodes are designed for data communication and network control via the CAN-bus on the basis of a protocol which is based on the/a CAN protocol and provides communication and network control in accordance with the master/client principle but preferably in accordance with the CAN open protocol, in which case one node, preferably the master node, is designed, is configured or can be configured as the master node for the protocol which provides the communication and network control in accordance with the master/client principle, and the other nodes are designed, are configured or can be configured as client nodes for the protocol which provides the communication and network control in accordance with the master/client principle.

31. Method for configuration of a network according to claim 25, in which at least one master node configures a plurality of client nodes, in that the master node successively sends at least one set message by means of the bus controller via the bus for each client node to be configured, which set message contains a nominal node identification associated with the respective client node, in which case the nodes to be configured are activated successively by application of a set signal (S₂) to their set input connection to set a nominal node identification, which is associated with them and is contained in a set message received via the bus connection, as the node identification.

32. Method according to claim 31, wherein the master node also sends next node set messages between the set messages and/or ends the emission of the set signal at its set output connection in order that an already configured node emits at its set output connection the set signal which a node that has not yet been configured receives at its set input connection.

33. Method according to claim 31, wherein the master node sends at least one acknowledgement request message via the bus connection in order to determine an instantaneous configuration state of the network.

34. Method according to claim 31, wherein the master node receives at least one acknowledgement message or confirmation message, which has been sent in response to the transmitted acknowledgement request and/or in response to the emission of the set signal (S₂) via the bus and/or in response to the transmitted next node set message and/or in response to the transmitted node set message, from a respective client node or the client nodes, and compares its content, which contains a node identification and a component identification, with predetermined network configuration data.

35. Method according to claim 34, wherein the master node sends or does not send the set message as a function of the content of the acknowledgement message and/or as a function of the comparison, and/or sends the set message with a nominal node identification which is dependent on the comparison and is defined on the basis of the network configuration data.
